(19) United States
(12) Patent Application Publication
(10) Pub. No.: US 2007/0014961 A1
(43) Pub. Date: Jan. 18, 2007

(54) Truncated corner paper toweling and method

(76) Inventors: Gregory M. Schneider, Cologne, MN (US); Louis F. Polk III, Excelsior, MN (US)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 11/183,258

(22) Filed: Jul. 15, 2005

(51) Int. Cl. G09F 3/00; B32B 3/02

(52) U.S. Cl. 428/43; 428/81; 428/80

(57) ABSTRACT

A paper towel, a roll of paper toweling, and a method of making the same that produces a paper towel sheet having perforated corners of tear-off construction that each leaves a truncated corner when torn off. Each such truncated corner preferably is radiused or rounded. The roll includes an elongate web of material that has a plurality of pairs of perforations that extend along a substantially straight line from one side edge to its other side edge defining a plurality of pairs of paper towel sheets with squared-off sheet corners. Each squared-off sheet corner is bounded by a plurality of pair of perforations that extend along a line that truncates the corner and produces a tear-off corner that leaves a truncated corner when torn off. In a preferred method, each dividing perforation line is formed substantially simultaneously with a pair of perforated corners of one adjoining sheet and a pair of perforated corners of the other adjoining sheet.

### CROSS REFERENCE TO RELATED APPLICATION

This application claims priority in and the benefit of U.S. Provisional Application No. 60/558,072, filed Jul. 15, 2004, the entirety of each of which is expressly incorporated by reference herein.

### FIELD OF THE INVENTION

The present invention is directed to paper toweling and a method of forming paper toweling, and more particularly to a sheet of paper toweling formed with perforable corners capable of being torn away and a method of forming one or more sheets of paper toweling, and which are particularly well suited for microwave use.

### BACKGROUND OF THE INVENTION

Square or rectangular paper towel sheets are ill-suited for use in microwave ovens because their squared-off corners frequently catch on one of the sidewalls or back walls of the microwave oven chamber. This can cause the paper towel sheet to fall off of the plate or bowl which it was intended to cover, causing food in the plate or bowl to splatter the inside of the microwave oven chamber. Where placed between the plate or bowl and the rotating pedestal of the microwave oven, the paper towel sheet can catch on part of the microwave oven chamber stopping rotation of the plate or bowl. This can create hot spots in the food in the plate of bowl during cooking, which can undesirably lead to burning or charring of the food.

What is needed is a paper towel, paper towel roll and method of making the same that produces a paper towel sheet that does not suffer from these disadvantages.

### SUMMARY OF THE INVENTION

The present invention is directed to a paper towel, a roll of paper toweling and a method of making the same that produces a paper towel sheet having perforated corners of tear-off construction that each leaves a truncated corner when torn off. Each such truncated corner preferably is radiused or rounded and can include one or more sacrificial tear away tabs to help retain each corner when adjacent paper towel sheets are being separated. The roll includes an elongate web of material that has a plurality of pairs of perforations that extend along a substantially straight line from one side edge to its other side edge defining a plurality of pairs of paper towel sheets with squared-off sheet corners. Each squared-off sheet corner is bounded by a plurality of pair of perforations that extend along a line that truncates the corner and produces a tear-off corner that leaves a truncated corner when torn off. In a preferred method, each dividing perforation line is formed substantially simultaneously with a pair of perforated corners of one adjoining sheet and a pair of perforated corners of the other adjoining sheet.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout and in which:

FIG. 1 is a top plan view of one preferred embodiment of a paper towel sheet that is perforated so as to produce truncated corners;

FIG. 2 is a side elevation view of the paper towel sheet shown in FIG. 1;

FIG. 3 is a bottom plan view of a paper towel sheet before removal of its perforated corners;

FIG. 4 is a perspective view of the paper towel sheet of FIG. 3 after removal of its perforated corners;

FIG. 5 is a perspective view of a radiused corner paper towel sheet in use in a microwave;

FIG. 6 is a perspective view of a roll of paper toweling with each sheet perforated with tear-off corners that are radiused or rounded;

FIG. 7 is a perspective view illustrating one preferred method of making a roll of paper toweling with each sheet having perforated tear-off corners;

FIG. 8 is a perspective view illustrating a second preferred method of making a roll of paper toweling with each sheet having perforated tear-off corners;

FIG. 9 illustrates another preferred embodiment depicting a plurality of paper towel sheets each having perforated tear-away corners of generally triangular construction;

FIG. 10 illustrates still another preferred embodiment having sacrificial tear-away tabs that enable one paper towel sheet to be torn away from its adjacent sheet without tearing away one or more of the perforated truncated corners; and

FIG. 11 illustrates a plurality of sheets similar to that depicted in FIG. 10 with each truncated corner defined by curvilinear perforation splines.

Before explaining the embodiments of the invention in detail, it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

### DETAILED DESCRIPTION OF AT LEAST ONE PREFERRED EMBODIMENT

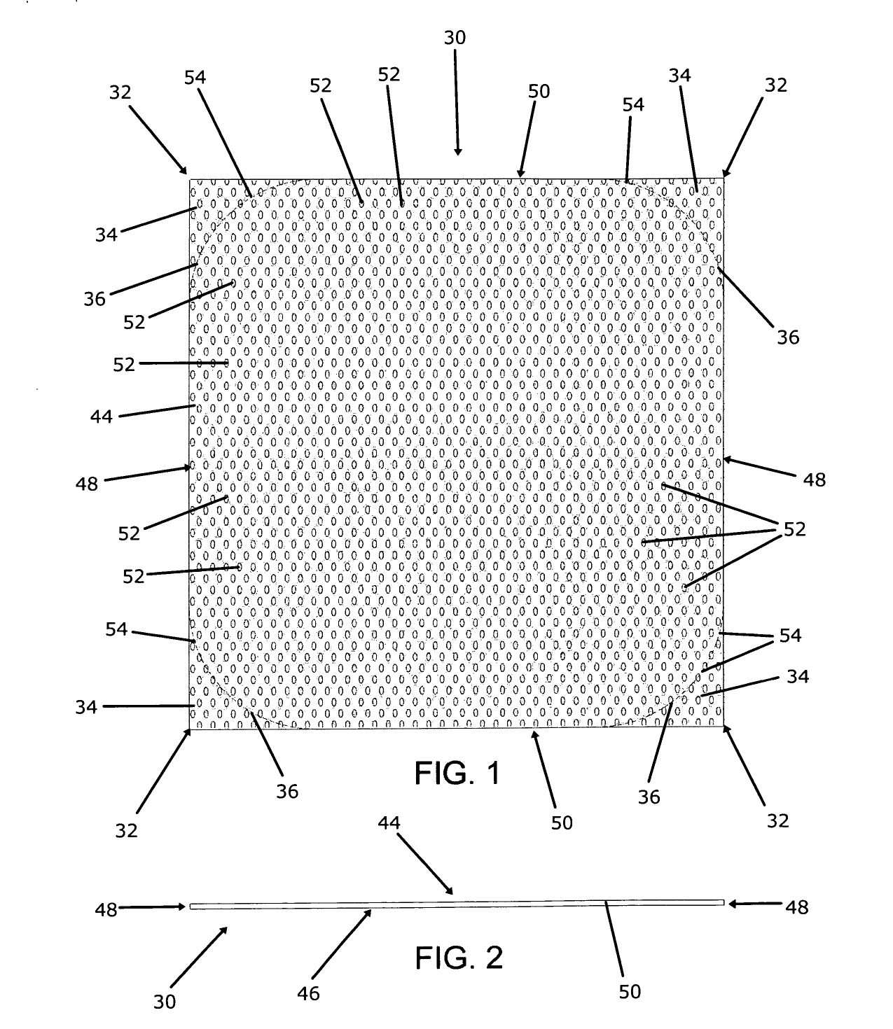

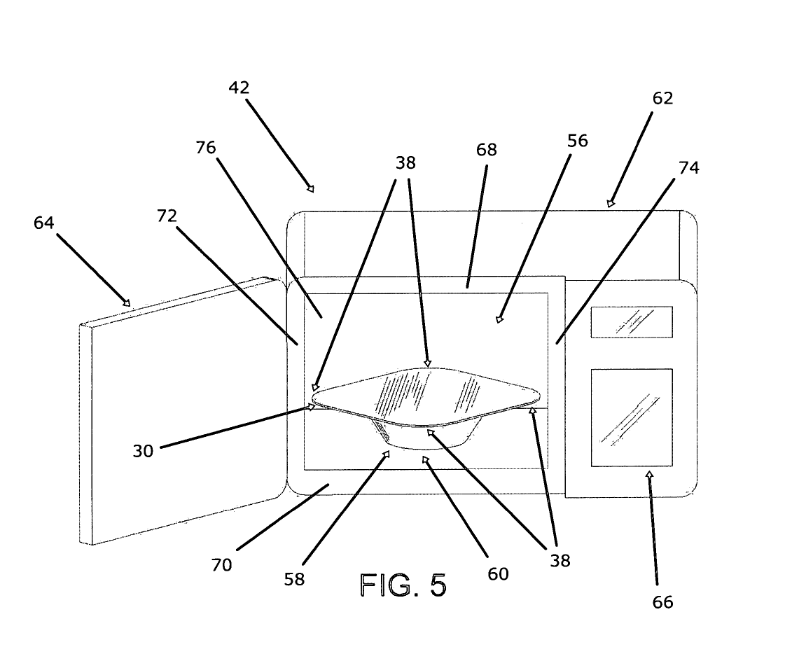

FIGS. 1-5 illustrates a preferred embodiment of a paper towel sheet 30 that has four squared-off corners 32, at least a plurality of which are of perforated tear-off construction 34. Each such corner 32 has a perforated portion 34, delineated by a curved perforation line 36 that can be manually grasped and torn off such that the resultant new corner 38 (FIG. 4) has a radiused or rounded outer edge 40. Thereafter, the paper towel sheet 30 is usable in a microwave oven 42 (FIG. 5) or the like without interference occurring between the oven 42 and any one of the radiused corners 38 of the paper towel sheet 30.

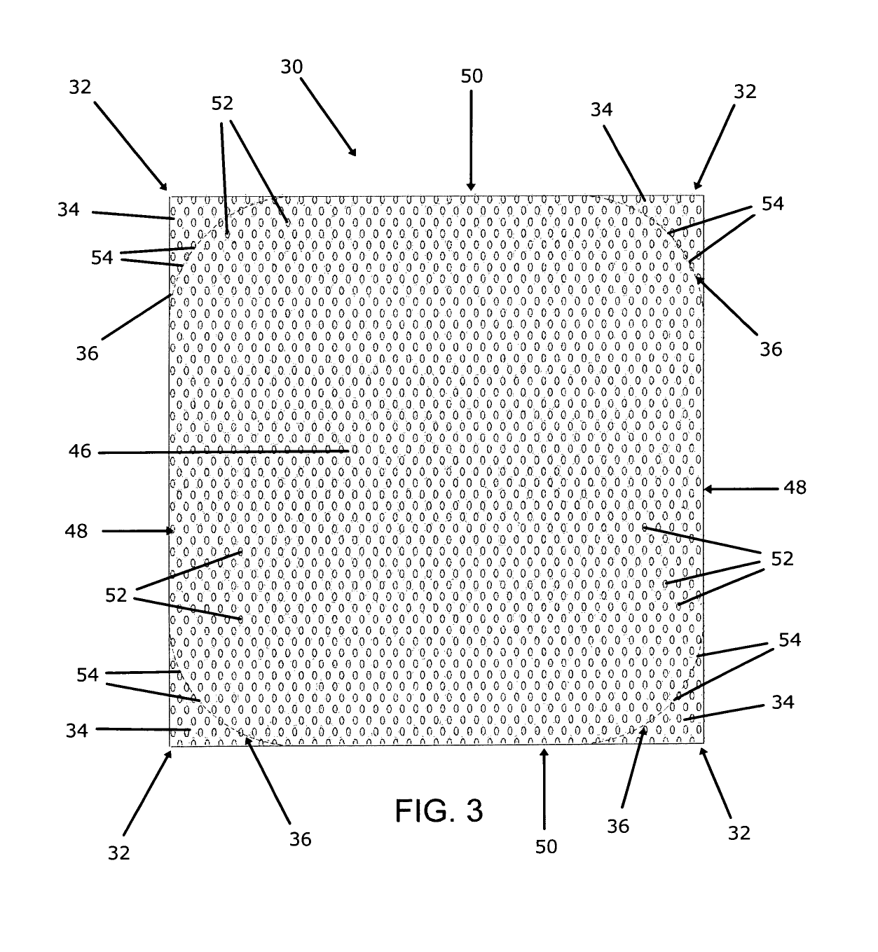

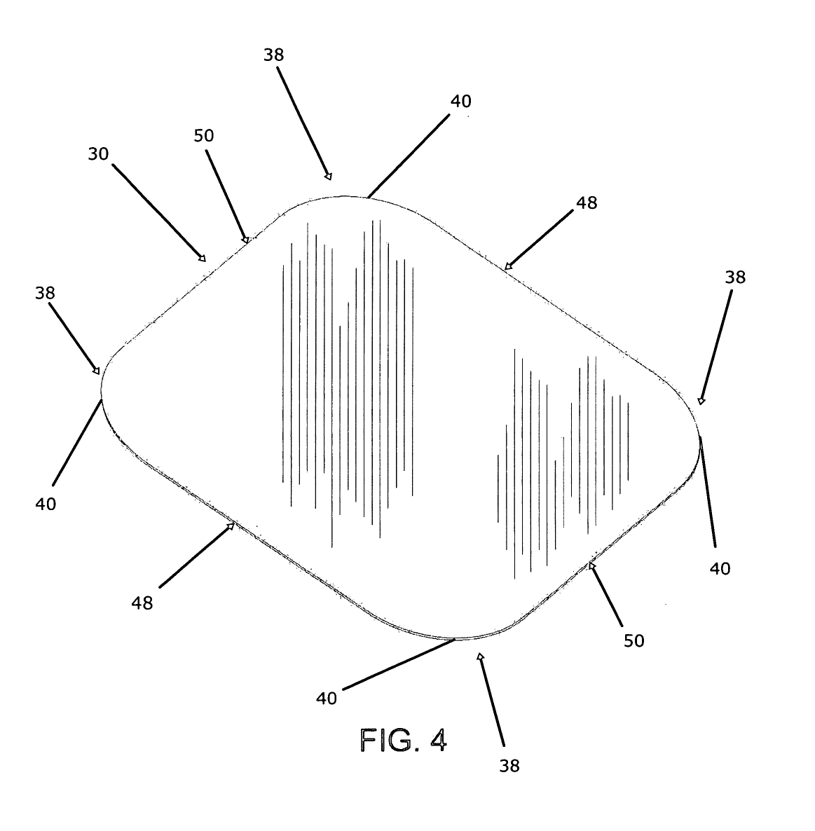

Referring once again to FIGS. 1-3, the paper towel sheet 30 has a top surface 44 (FIG. 1), a bottom surface 46 (FIG. 3), and a plurality of pairs of oppositely extending side edges 48 and 50 and is substantially planar when laid upon a substantially planar surface (not shown). Each squared-off corner 32 is formed by the intersection of one side edge 48 and one side edge 50. The sheet 30 preferably is of substantially rectangular construction and can be square, if desired.

The sheet 30 preferably is made of a fibrous matter that includes pulp fiber or fabric fiber, and can include both. The sheet 30 preferably is creped and embossed to improve its ability to absorb and hold liquid. The sheet 30 has a thickness of between four mils and twenty mils. The sheet 30 has a preferred thickness of between about eight mils and about twelve mils. The sheet 30 preferably is of multi-ply construction having at least a plurality of plies or layers.

The preferred embodiment of the sheet 30 shown in FIGS. 1-3 includes a plurality of pairs of spaced apart and visually perceptible embossments 52 (i.e., at least three) formed in its top surface 44, its bottom surface 46, or both its top surface 44 and its bottom surface 46. The embossments 52 preferably are arranged in an array such that at least one of its surfaces 44 and/or 46 is substantially completely covered by them. In the preferred sheet embodiment shown in FIGS. 1-3, the sheet 30 has a plurality of pairs of rows of embossments 52 and a plurality of pairs of columns of embossments 52. Each of the embossments 52 are oblong, preferably oval, but can have another shape, if desired.

Each perforated tear-off portion 34 has a radiused or rounded perforation line 36 that consists of a plurality of pairs of holes 54 that each extends at least part of the way through one or both surfaces 44 and 46 and that are collectively arranged in a line 36 that is curved. Each perforation line 36 has a radius of curvature of at least two inches or larger. In a presently preferred embodiment, each perforation line 36 has a continuously varying radius of curvature or a radius of curvature that is not constant.

FIG. 4 depicts the paper towel sheet 30 after each one of its tear-off corners 34 has been removed. The sheet 30 has four rounded corners 38 each with a curved side edge 40. Between each pair of adjacent rounded corners 38 is a straight edge, such as edge 48 or edge 50. The end result is a paper towel sheet 30 that has two pairs of substantially straight edges 48 and 50 and four rounded or curved corners 38. Each corner 38 of the preferred sheet embodiment shown in FIG. 4 has a fixed radius of curvature. If desired, each corner 38 can have a radius of curvature that is not constant such that it varies along its curved outer edge 40.

FIG. 5 illustrates the paper towel sheet 30 disposed in an oven chamber 56 of a microwave oven 42. The sheet 30 overlies a bowl or plate 58 that is received on a pedestal 60 of the microwave 42 that rotates during microwave operation. If desired, the sheet 30 can be placed underneath the bowl or plate 58 such that it lies between it and the pedestal 60.

The microwave 42 includes an outer housing 62 with a latchable door 64 that is releasably closed to cover the oven chamber 56 during microwave operation. The microwave 42 also includes a control panel 66 located next to the oven chamber 56. The oven chamber 56 is defined by a top wall 68, a bottom wall 70, a pair of sidewalls 72 and 74, and a back wall 76 located behind the bowl or plate 58.

During microwave operation, the door 64 is latched closed and the pedestal 60 rotates. As the pedestal 60 rotates, the bowl or plate 58 and paper towel sheet 30 rotate in unison with the pedestal 60. As the paper towel sheet 30 is rotated, each of its curved corners 38 advantageously clears each sidewall 72 and 74 and back wall 76 of the oven chamber 56. By providing curved paper towel sheet corners 38, the paper towel sheet 30 does not contact either sidewall 72 and 74 and the back wall 76 of the oven chamber 56. As a result, the paper towel sheet 30 does not fall off the bowl or plate 58. This advantageously prevents food from within the bowl or plate 58 from splattering into the microwave oven chamber 56, helping to keep the oven chamber 56 clean. Where the paper towel sheet 30 underlies the bowl or plate 58, the sheet 30 and bowl or plate 58 keeps rotating in unison with the pedestal 60 thereby preventing the formation of hot spots in the food in the bowel or plate 58 that typically occurred in the past when conventional square corner paper towel sheets were used.

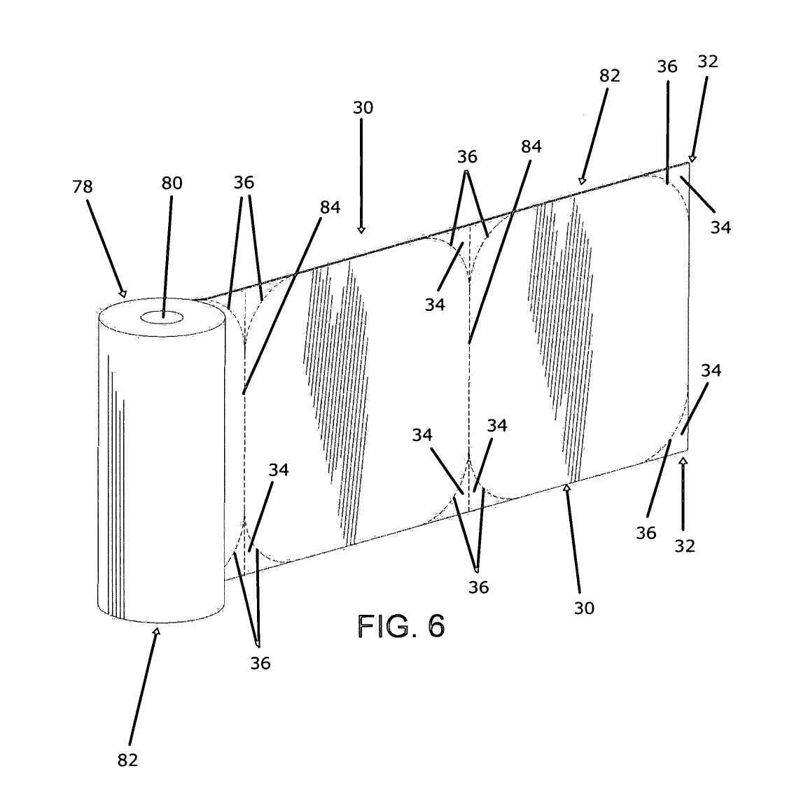

FIG. 6 illustrates a preferred embodiment of a generally cylindrical roll of paper toweling 78 that has a plurality of pairs of paper towel sheets 30 wrapped around a hollow and generally cylindrical core 80, that preferably is made of cardboard, fiberboard, Kraft board, or the like. As is noted in FIG. 6, the paper toweling roll 78 consists of an elongate generally rectangular web of fibrous paper towel material 82 that is wrapped around and preferably attached to the core 80. The paper toweling web 82 preferably is at least twenty-five feet in length and includes at least twenty five sheets 30.

Each sheet 30 is divided from an adjoining sheet 30 by a transversely extending perforation line 84 that preferably is substantially straight. As previously discussed, each sheet 30 has a perforation line 36 about each of its squared-off corners 32 that permits a portion 34 of each corner 32 to be torn off to leave a truncated corner 38 that preferably is radiused or curved like the curved corners 38 shown in FIGS. 4 and 5. As is also shown in FIG. 6, each corner perforation line 36 of each sheet 30 preferably converges with the corner perforation line 36 of an adjoining sheet 30 such that both corner perforation lines 36 converge with the transversely extending perforation line 84 that divides the adjoining sheets 30.

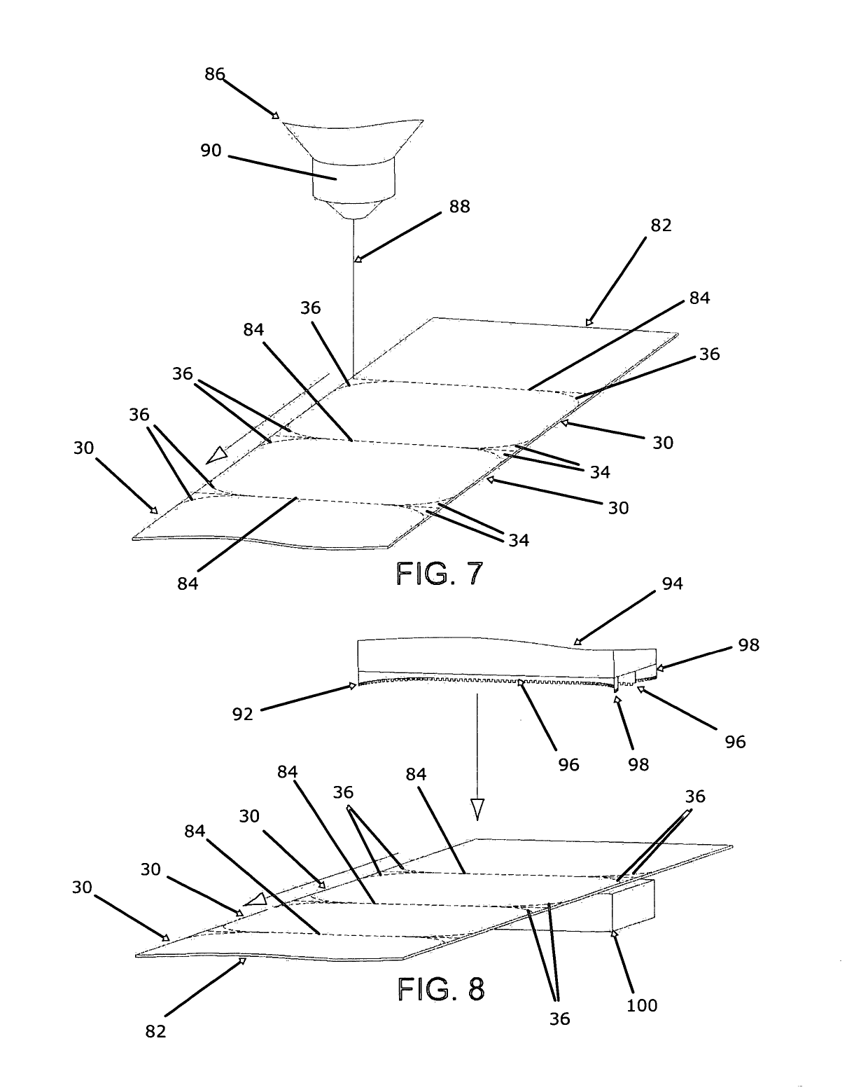

FIG. 7 illustrates one preferred method of making a paper toweling roll 78 having sheets 30 with tear away corner portions 34 that can be torn away to leave truncated sheet corners 38 that preferably are curved or radiused that produces paper toweling sheets 30, each of which is particularly well suited for use in a microwave oven 42. A web of paper towel material 82 passes by a source of high energy density radiation 86 that focuses a beam 88 onto the web 82 to perforate it in the desired manner. In one preferred embodiment, the source of high energy density radiation 86 comprises a laser that produces a beam 88 that is a laser beam. The beam 88 impinges against the web 82, selectively burning or vaporizing it to produce the desired pattern of perforations. Such an arrangement preferably is employed before the paper toweling web 82 material is wrapped around the core 80.

The source of high energy density radiation 86 includes a head 90 and a focusing arrangement (not shown) used to focus and/or aim the beam 88. If desired, the head 90 can be carried by a robot or a gantry (not shown) used to move the head 90 relative to the web 82 to position the beam 88 so it accurately perforates it. The beam 88 can be pulsed to produce regions of imperforated web between adjacent perforations.

While a laser is preferred, other types of high energy density radiation beams can be employed. For example, the beam can be or include an electron beam or a beam of radiation, such as a beam of suitably accelerated alpha particles.

In another preferred embodiment, perforations are formed using a fluid propelled at a high velocity toward the paper towel web. Although not shown, such a fixture can simultaneously apply the fluid via a delivery arrangement that includes injectors or nozzles arranged in the desired perforation pattern or patterns. Such a fixture can be composed of a head with an array of nozzles and/or selectively controllable injectors to form the side-to-side towel perforations as well as any desired tear away truncated corner perforation. Such a fluid can be a liquid, such as a water jet that is pulsed to produced one or more perforations in a desired location, as well as a gas, such as air that impinges against and through part of the paper towel or web thereof to form the desired perforations.

FIG. 8 illustrates another preferred method of making a paper toweling roll 78 having sheets 30 with tear away corner portions 34 that can be torn away to leave truncated sheet corners 38 that preferably are curved or radiused that produces paper toweling sheets 30, each of which is particularly well suited for use in a microwave oven 42. A web of paper towel material 82 passes by a perforating die 92 that is brought to bear against the web 82 to perforate it in the desired manner. In the preferred embodiment shown in FIG. 8, the die 92 engages the web 82 to substantially simultaneously produce the corner perforation lines 36 and a single sheet dividing perforation line 84 for each pair of adjacent sheets 30. If desired, the die 92 can be constructed and arranged to substantially simultaneously do so for a plurality of pairs of sheets 30. If desired, a plurality of such dies 92 can be used.

The perforating die 92 is carried by a reciprocating carriage 94 that is rapidly moved toward the web 82 to perforate it and then moved away from the web 82 so the web 82 can advance. The die 92 includes a plurality of serrated blades 96 and 98 that each engage the web 82 to form one of the perforation lines 36 and 84. The die 92 has a straight serrated blade 96 that produces the sheet dividing perforation line 84 and a pair of curved blades 98 adjacent each end of the straight serrated blade 96 that each form one of the corner perforation lines 36. A bed 100 is located on the opposite side of the web 82 and receives the die 92 when it engages the web 82.

If desired, such a die 92 can be formed as part of a rotating roll (not shown), such as part of a calendar roll, drying roll, embossing and/or creping roll, or the like that engages the web of paper toweling to impart the desired perforation pattern to form paper towel sheets having perforable tear-away corners. Such a roll (not shown) can be disposed just downstream of the wet end, such as where the paper toweling web is dried, or at or along a finishing section, depending on, for example, advantages, speed, efficiency and perforation effectiveness achieved.

One or more of the perforation arrangements and methods disclosed herein in accordance with the present invention can be suitably adapted for perforating folded paper towels, if desired. Preferably, in one preferred embodiment and method, one of the perforating arrangement disclosed above, including those shown in FIGS. 7 and 8, can be adapted to form the sheet perforations and truncated corner perforations. In one preferred embodiment and method according to the present invention, the sheet and truncated corner perforations are formed just before, during, and/or just after folding is performed.

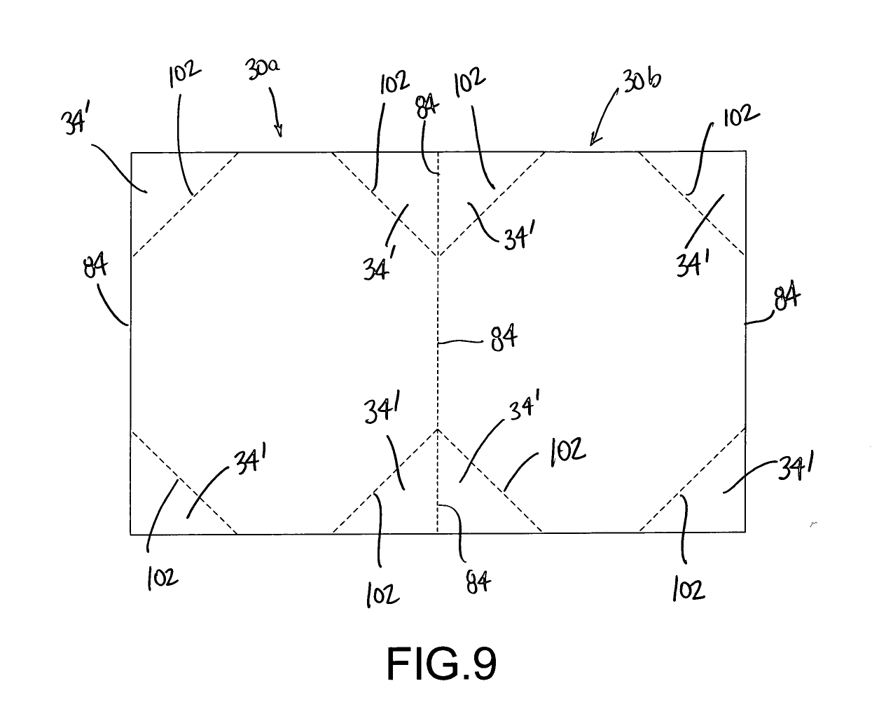

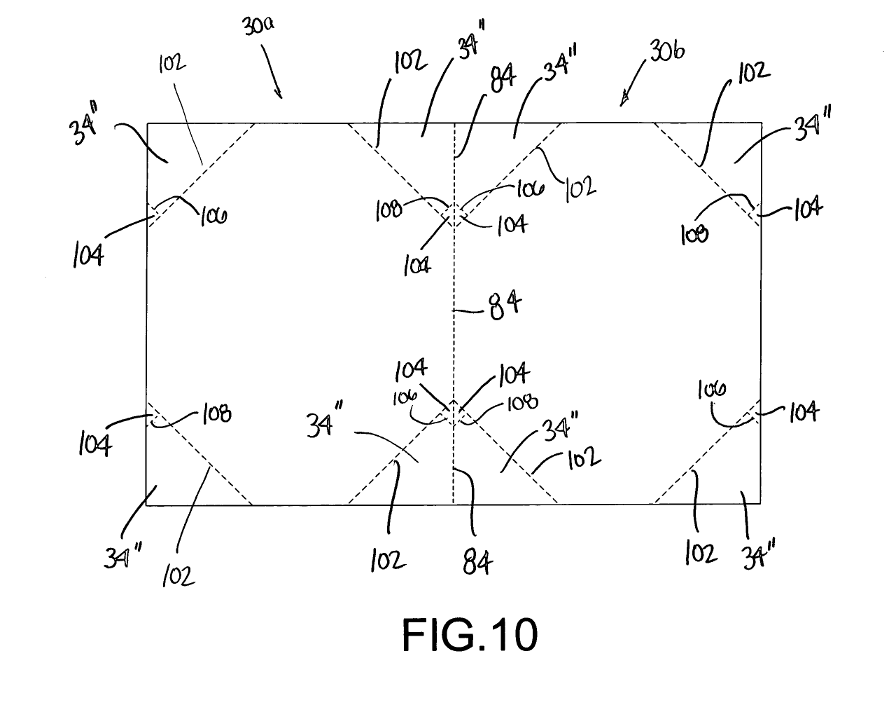

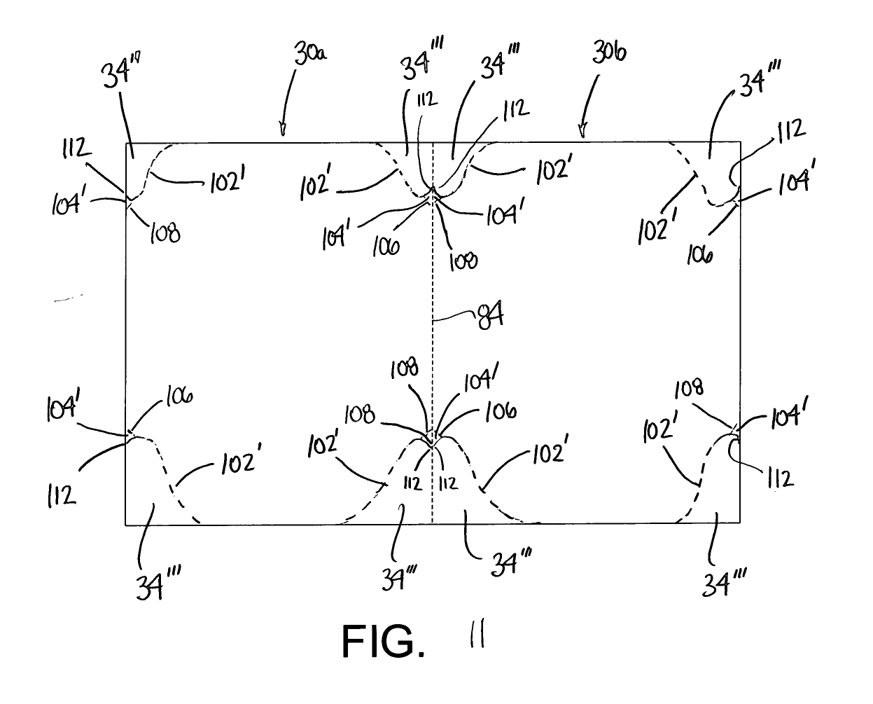

FIG. 9 depicts another preferred paper towel embodiment having straight truncated corner perforations 102 defining truncated corners 34′. FIG. 10 illustrates an embodiment similar to FIG. 9, but with the addition of perforate sacrificial tabs 104 that can tear away as one sheet 30a is separated from adjacent sheet 30b by tearing the side-to-side perforation, i.e., sheet divider perforation 84, therebetween. During tearing of one sheet 30a from the adjacent sheet 30b, one or more sacrificial tabs 104 can be torn away with each preferably being of vee-shaped or notched constructed as defined by its perforation lines 106 and 108 to prevent migration of any part of the tear being manually made into any one of the truncated corner perforations 102 of each sheet 30a and 30b lying along the side-to-side sheet dividing perforation 84. Such sacrificial tabs 104 can be made even smaller than that shown in FIG. 10, such as where it is desired to maximize the real estate of each corner 34″. This also maximizes the absorbent surface are and volume of each paper towel sheet 30a and 30b.

FIG. 11 illustrates perforate truncated corners 34′″ defined by curvilinear spline-type perforations 102′ that each can have a in-turned lead 112 intersecting the adjacent sheet perforation 84. If desired, sacrifical tear-away perforated tabs 34′″ can be employed that extend from each curvilinear spline-type perforation 102′ to the sheet perforation 84 and adjacent the in-turned perforated lead 112.

In one preferred method and perforation arrangement, the sheet perforations are constructed to enable adjacent sheets to be torn away from one another with less effort than that required to tear away each perforated truncated corner. In one preferred implementation, truncated corner perforations are smaller thereby resulting in perforations requiring greater force to tear than sheet perforations. Depending on a desired ratio of tear strengths of sheet perforation strength to truncated corner perforation strength that achieves consistent and preferable optimal tearing of the sheet without tearing any corner (until intentionally done by a user), sacrificial tear away tabs may not be needed. Where a sacrificial tear away tab is employed, the perforations defining each such tab preferably are constructed or otherwise formed to provide a tear strength between that of the sheet dividing perforation line 84 and the perforation(s) defining each tear away perforated truncated corner 34.

It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

What is claimed is:

1. A sheet of paper toweling comprising a generally rectangular panel that has a plurality of truncated non-square corners.

2. The sheet of claim 1 wherein each corner is of radiused construction.

3. The sheet of claim 2 wherein the sheet has four radiused corners with one radiused corner located at each one of the four corners of the sheet.

4. A plurality of sheets of paper toweling comprising a generally rectangular panel that each has four squared-off corners each bounded by a corner perforation line permitting a portion of each squared-off corner to be torn off to produce a truncated corner thereat and one of the sheets removably attached to the other one of the sheets by a perforation extending from one side of the sheets to the opposite of the sheets.

5. The sheet of paper toweling of claim 4 wherein each truncated corner is rounded or curvilinear with one end of each truncated corner perforation adjoining or terminating at the side-to-side sheet perforation.

6. A sheet of paper toweling comprising a generally rectangular panel that has four squared-off corners each bounded by a perforation line that permits a portion of each squared-off corner to be torn off to produce a truncated corner wherein the panel has four substantially straight side edges with each one of the side edges extending from one truncated corner to another truncated corner.

7. A sheet of paper toweling comprising of a sheet creped and embossed fibrous material having a thickness between four mils and twenty mils, the sheet having four squared-off corners, each of which is bounded by a perforation line that defines a tear-off portion that, when torn off, leaves a round corner.

8. A roll of paper toweling comprising a web of fibrous material comprised of a plurality of pairs of sheets with each sheet divided from an adjacent sheet by a perforation line that extends from one side edge of the web to the other side edge of the web and each sheet having a perforation line along each corner defining a tear-off corner that can be torn off to produce a truncated corner.

9. A roll of paper toweling comprising a web of fibrous material comprised of a plurality of pairs of sheets with each sheet divided from an adjacent sheet by a perforation line that extends from one side edge of the web to the other side edge of the web and each sheet having a perforation line along each corner defining a tear-off corner that can be torn off to produce a rounded corner.

10. A roll of paper toweling comprising a web of fibrous creped and embossed material composed of paper fiber having a thickness between four mils and twelve mils that comprises a plurality of pairs of sheets with each sheet divided from an adjacent sheet by a perforation line that extends from one side edge of the web to the other side edge of the web with each sheet having a curved perforation line that bounds each corner defining a tear-off corner that can be torn off to produce a rounded corner.

11. A method of making a roll of paper toweling comprising:
(a) providing a web of fibrous material;
(b) perforating the web along a substantially straight line extending from one side edge of the web to the other side edge of the web dividing the web into a plurality of paper toweling sheets; and
(c) perforating each sheet around each one of its corners to produce a tear-off corner.

12. The method of claim 11 wherein a laser is used to perforate the web to form each sheet and define each tear-off corner.

13. The method of claim 11 wherein a die is used to perforate the web to form each sheet and define each tear-off corner.

14. The method of claim 13 wherein the die has a plurality of serrated blades that substantially simultaneously perforate the web to define a pair of adjoining sheets and to define a pair of tear-off corners of one of the adjoining sheets and a pair of tear-off corners of the other one of the adjoining sheets.

15. A method of making a roll of paper toweling comprising:
(a) providing a web of fibrous material;
(b) perforating the web along a substantially straight line extending from one side edge of the web to the other side edge of the web dividing the web into a plurality of adjoining paper toweling sheets; and
(c) perforating each sheet around each one of its corners to produce a tear-off corner that is rounded.

16. A method of making a roll of paper toweling comprising:
(a) providing a web of embossed and creped fibrous material that has a thickness of between four mils and twelve mils;
(b) perforating the web along a substantially straight line extending from one side edge of the web to the other side edge of the web dividing the web into a plurality of adjoining paper toweling sheets; and
(c) perforating each sheet around each one of its corners to define a curved perforation line that produces a tear-off corner that leaves a rounded corner when torn off.

17. A method of making a roll of paper toweling comprising:
(a) providing a web of embossed and creped fibrous material that has a thickness of between four mils and twelve mils;
(b) perforating the web along a substantially straight line extending from one side edge of the web to the other side edge of the web dividing the web into a plurality of adjoining paper toweling sheets and defining a pair of squared-off corners for each one of the adjoining paper toweling sheets;
(c) perforating each one of the adjoining paper toweling sheets along each one of the pair of its squared-off corners to produce a tear-off corner the leaves a truncated corner when torn off; and
(d) wherein the perforating steps (b) and (c) are performed substantially simultaneously.

18. A method of making a roll of paper toweling comprising:
(a) providing a web of embossed and creped fibrous material that has a thickness of between four mils and twelve mils;
(b) perforating the web along a substantially straight line extending from one side edge of the web to the other side edge of the web dividing the web into a plurality of pairs of adjoining paper toweling sheets and defining a pair of squared-off corners for each one of the plurality of pairs of adjoining paper toweling sheets;
(c) perforating each one of the plurality of pairs of adjoining paper toweling sheets along each one of the pair of its squared-off corners to produce a tear-off corner the leaves a radiused corner when torn off; and
(d) wherein the perforating steps (b) and (c) are performed substantially simultaneously for each pair of adjoining paper toweling sheets.
